(19) United States
(12) Patent Application Publication
(10) Pub. No.: US 2017/0220070 A1
(43) Pub. Date: Aug. 3, 2017

(54) LAPTOP CASE WITH HARD DRIVE ENCLOSURE

(71) Applicant: Justin Clark, Beverly Hills, CA (US)

(72) Inventor: Justin Clark, Beverly Hills, CA (US)

(21) Appl. No.: 15/010,269

(22) Filed: Jan. 29, 2016

(51) Int. Cl. G06F 1/16; G06F 13/38; G06F 13/42

(52) U.S. Cl. CPC G06F 1/1632; G06F 13/4282; G06F 13/385; G06F 1/1658; G06F 1/1628

(57) ABSTRACT

Provided is a system for attaching an external hard drive to a portable or laptop computer. The system comprises a laptop case with a built-in hard drive enclosure. The case also includes a SATA to USB converter for interfacing between the hard drive and the laptop. The hard drive enclosure may be sized to accommodate a 2.5 inch hard drive of various dimensions. The hard drive enclosure may have sloped sides to limit snagging and/or catching.

### FIELD OF THE INVENTION

This disclosure relates generally to systems and methods for attaching an external hard drive to a portable or laptop computer.

### BACKGROUND

At present, laptop computers are limited in the amount of permanent storage capacity they contain. Most laptops contain a hard disk drive with a limited amount of storage, and it is generally difficult to add further storage capacity. There exist external hard disk drives, and hard disk drive enclosures, but the drives and/or enclosures presently existing require the user go through a tedious procedure each time the laptop is transported. All open files being run from the drive must be shut down, and the hard disk drive and associated cable(s) must be packed. Many users find this procedure annoying.

### SUMMARY

The present invention comprises a laptop protective case that simultaneously serves as a hard drive enclosure for a hard drive. The hard drive can be of any form factor, e.g., 2.5 inches.

An object of the present invention is to develop a laptop case that can quadruple the storage capacity of today's laptops, including ultrabooks, while minimally affecting the aesthetic appeal of the original device, and without reducing its mobility.

Another object of the present invention is to develop a laptop case where an external hard drive be inserted and set up to run very quickly.

Another object of the present invention is to develop a laptop case where an external hard drive can be easily swapped for another hard drive, and the external hard drive doesn't need to be disconnected when the user needs to transport the laptop, e.g., wants to put the laptop in a bag or backpack.

### BRIEF DESCRIPTION OF DRAWINGS

Embodiments are illustrated by way of example and not limitation in the figures of the accompanying drawings, in which like references indicate similar elements and in which:

FIG. 1 illustrates an embodiment of a top hardshell according to an aspect of the present invention.

FIG. 2 illustrates another embodiment of a top hardshell according to an aspect of the present invention.

FIG. 3 illustrates yet another embodiment of a top hardshell according to an aspect of the present invention.

FIG. 4 illustrates another embodiment of a bottom hardshell according to an aspect of the present invention.

FIG. 5 illustrates another embodiment of a bottom hardshell according to an aspect of the present invention.

### DETAILED DESCRIPTION

The following detailed description includes references to the accompanying drawings, which form a part of the detailed description. The drawings show illustrations in accordance with example embodiments.

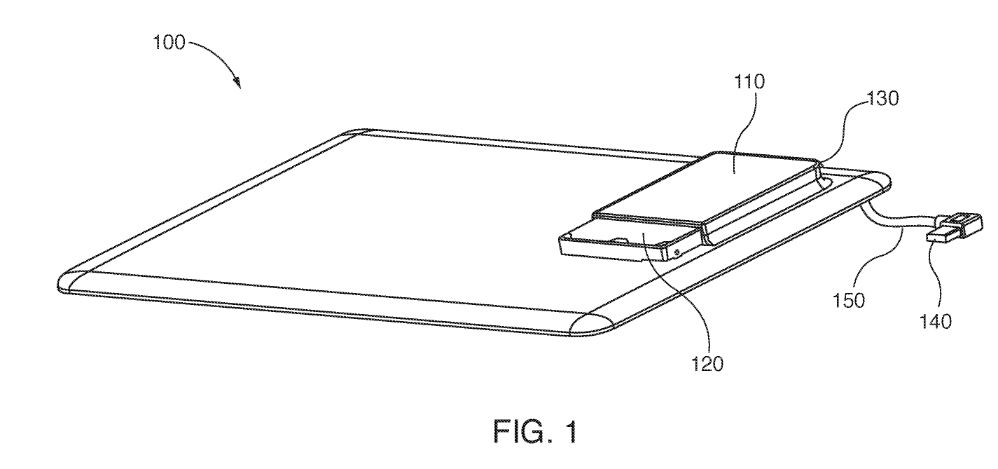

FIG. 1 illustrates an embodiment of the present invention. Laptop case top hardshell 100 includes hard drive enclosure 110 for the easy insertion and removal of external hard drive 120. Hard drive enclosure 110 may be variously sized to accommodate various sizes of hard drives. For example, hard drive enclosure 110 may be sized to accommodate 2.5 inch form factor hard drives, which can range in thickness between 5 mm and 9.5 mm. Hard drive enclosure 110 may also be sized to accommodate other sizes and/or types of external drives, without limitation.

Top hardshell 110 further comprises converter device 130, including an internal interface (not shown) inside hard drive enclosure 110 to which hard drive 120 attaches. This interface can be any of the current or future standard hard drive interfaces, e.g., Parallel ATA (PATA), IDE, Serial ATA (SATA), SCSI, Serial Attached SCSI (SAS), and/or Fibre Channel. Converter device 130 also includes external interface 140, which attaches to the laptop at a port. External interface 140 can be any of the current or future standard laptop interfaces, e.g., Universal Serial Bus (USB) 3.0 and prior versions. External interface 140 may be low profile, so that it minimally extrudes from the side of the laptop when inserted.

External interface 140 is connected to the internal interface (not shown) using cable 150. Cable 150 may be Flat Flexible Cable (FFC) or Flat Printed Cable (FPC) in order to maintain mobility, sleekness, and low profile. Cable 150 runs from the internal interface housed in the top (monitor side) of the hardshell, to external interface 140. External interface 140 may be plugged into a USB slot on the laptop. Converter device 130 enables hard drive 120 to interface with the laptop, and may be one of the commercial SATA to USB adapter devices presently available. Converter device 130 is installed in such a manner as to remain secured during the use of the product

Top hardshell 110 further comprises a means of being secured to the laptop. In one embodiment, the hardshell is secured using plastic tabs that grasp the laptop around the edges. In an alternative embodiment, the hardshell is secured by a rib which functions in much the same way as a tab, except instead of being discrete, the rib runs along the entire rim of the laptop case. Using a rib can be less invasive since the rib can be a very small protrusion, but still secure the case to the laptop since it has a greater total contact with the laptop edges. Which particular method will be used depends on the laptop for which the hardshell will be fitted, and the material used for the hardshell. More flexible materials may mandate tabs or ribs, and of different sizes, in order to secure the case. One of ordinary skill in the art will recognize alternative means for securing the hardshell to the laptop.

Top hardshell 110 may be made out of one, or a combination of, various plastics, as will be understood by one of ordinary skill in the art. The plastic chosen will depend on the style of the hardshell design, including transparent, colored and matte finishes, etc. Other materials may also be used, as one of ordinary skill in the art will understand.

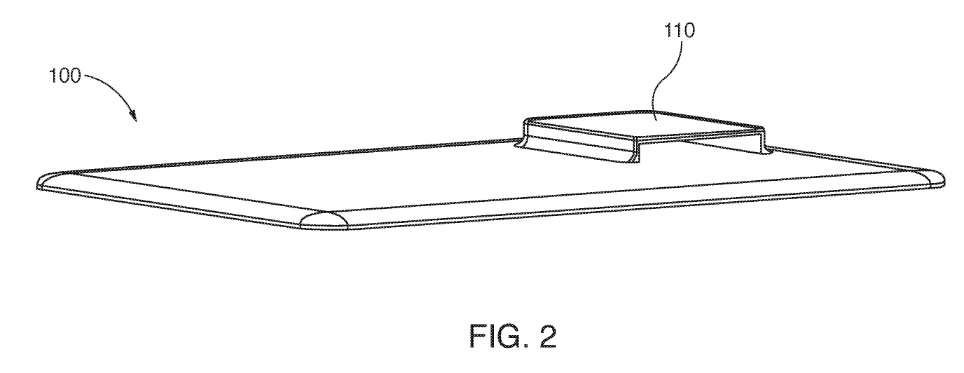

FIG. 2 shows hardshell 100 from a different angle. In FIG. 2, hard drive 120 and converter device 130 are not shown for clarity.

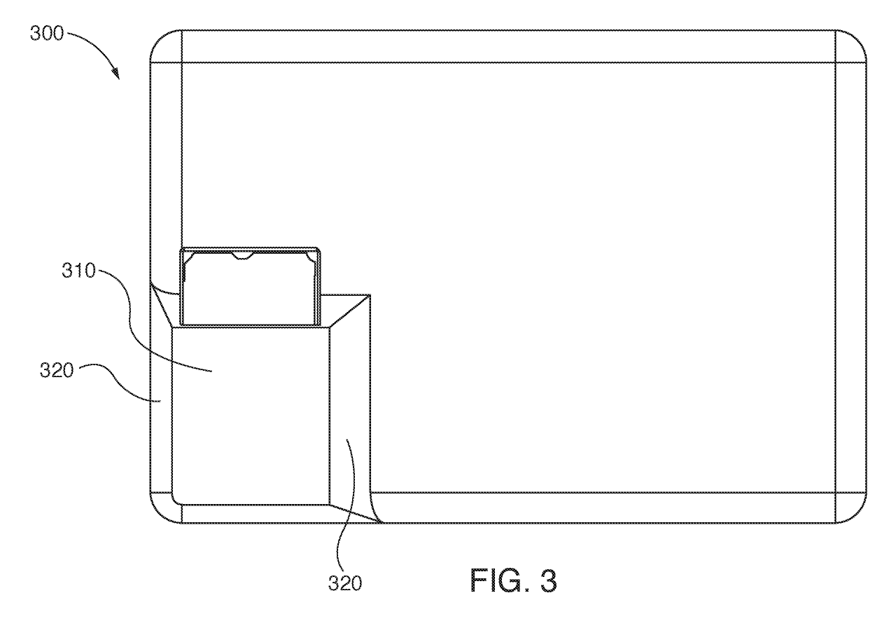

FIG. 3 illustrates an embodiment of hardshell 300 including sloped sides 320. In this embodiment, hard drive enclosure 310 extrudes from the laptop surface, but this extrusion is gradual enough so as not to snag on anything, but not so broad and gradual as to increase the general thickness of the laptop. Sloped sides 320 of hard drive enclosure 310 enable the extrusion to be relatively local, but not so local as to have sides or edges that could easily catch on fabric, books, or anything else that may be in a bag or backpack. The angle of sloped sides 320 can vary depending on the application.

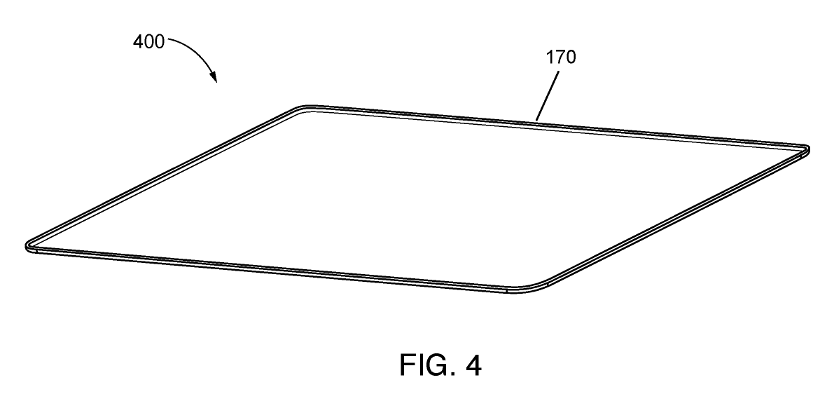

FIG. 4 illustrates the bottom half of the hardshell 400.

The laptop case according to the present invention may also include a bottom hardshell 400, which may comprise slots built into the hardshell to enable external interface 140 to be inserted into a USB or other port of the laptop.

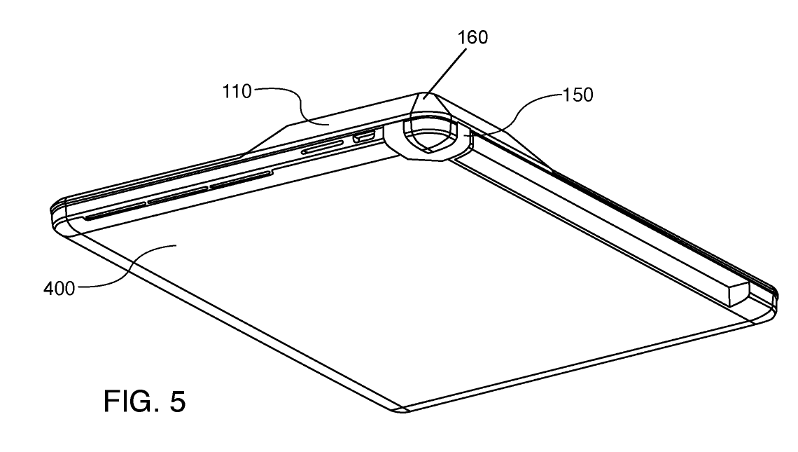

FIG. 5 illustrates an embodiment of bottom hardshell 400 with cable 150 extending from top hardshell 110 through bottom hardshell 400.

Bottom hardshell 400 may be made out of one, or a combination of, various plastics, as will be understood by one of ordinary skill in the art. The plastic chosen will depend on the style of the hardshell design, including transparent, colored and matte finishes, etc. Other materials may also be used, as one of ordinary skill in the art will understand.

Although the invention has been described in terms of particular embodiments, one of ordinary skill in the art, in light of the teachings herein, will be able to generate additional embodiments and modifications without departing from the spirit of, or exceeding the scope of, the claimed invention. This invention is not limited to using the particular elements, materials, or components described herein, and other elements, materials, or components will be equivalent for the purposes of this invention. Accordingly, it is understood that the drawings and the descriptions herein are proffered only to facilitate comprehension of the invention and should not be construed to limit the scope thereof.

What is claimed is:

1. A laptop case, comprising:
a. a top hardshell including a hard drive enclosure;
b. an adapter for interfacing between a hard drive and a laptop; and
c. a bottom hardshell.

2. The case of claim 1, wherein the hard drive enclosure is sized to accommodate a 2.5 inch hard drive.

3. The case of claim 2, wherein the height of the hard drive enclosure is between 5 mm and 9.5 mm.

4. The case of claim 1, wherein the adapter comprises two interfaces, and wherein the bottom hardshell comprises slots to accommodate the inserting of one of the two interfaces into a port of the laptop.

5. The case of claim 4, wherein the port is a USB port.

6. The case of claim 1, further comprising sloped sides between the hard drive enclosure and the rest of the top hardshell.

7. The case of claim 1, wherein the adapter is a SATA to USB adapter.

8. A top hardshell of a laptop case, comprising:
a. a shell;
b. means for temporarily attaching the shell to a laptop;
c. means for holding a hard drive; and
d. means for interfacing between the hard drive and the laptop.

9. The top hardshell of claim 8, wherein the means for temporarily attaching the shell to a laptop comprises a rib running along the entire edge of the top hardshell.

10. The top hardshell of claim 8, wherein the means for temporarily attaching the shell to a laptop comprises one or more tabs.

11. The top hardshell of claim 8, wherein the means for holding a hard drive is sized to accommodate a 2.5 inch hard drive.

12. The top hardshell of claim 11, wherein the means for holding a hard drive is sized to accommodate a hard drive with a height between 5 mm and 9.5 mm.

13. The top hardshell of claim 8, wherein the means for interfacing comprises a SATA to USB adapter.

14. The top hardshell of claim 8, further comprising sloped sides between the shell and the means for holding.
